(19) United States
(12) Patent Application Publication
(10) Pub. No.: US 2026/0178325 A1
(43) Pub. Date: Jun. 25, 2026

(54) MATRIX MULTIPLICATION SCHEDULING BASED ON REPEATED MATRICES

(71) Applicant: ADVANCED MICRO DEVICES, INC., Santa Clara, CA (US)

(72) Inventors: Shubra Marwaha, Santa Clara, CA (US); Bin He, Orlando, FL (US); Subramaniam Maiyuran, Folsom, CA (US)

(21) Appl. No.: 18/987,106

(22) Filed: Dec. 19, 2024

(51) Int. Cl. G06F 9/30

(52) U.S. Cl. CPC G06F 9/30036; G06F 9/3001; G06F 9/30098

(57) ABSTRACT

An accelerator unit (AU) including vector registers and one or more processor cores is configured to schedule instructions for execution that share one or more matrix block. To this end, the AU maintains tracking entries for the hardware buffers of one or more of these processor cores with each tracking entry indicating vector register addresses associated with the corresponding matrix block loaded into the hardware buffer. When the AU schedules an instruction indicating a matrix multiplication operation for execution, the AU compares the vector register addresses indicated in the instruction to the tracking entries of the hardware buffers. In response to the vector register addresses in the instruction matching a tracking entry, the AU suppresses a read request to the vector registers and uses data from a corresponding hardware buffer to perform the matrix multiplication operation.

### BACKGROUND

To implement certain machine-learning models, some processing systems include specialized processing units, such as graphics processing units (GPUs), configured to perform dot-product operations using matrices that represent the weights and biases of the machine-learning models. To have a specialized processing unit perform such dot-product operations, a central processing unit (CPU) of the processing system sends a stream of instructions to the specialized processing unit that indicates the dot-product operations to be performed. The specialized processing unit then schedules these instructions for execution by storing data representing the matrices to be multiplied in the vector registers of the specialized processing unit. From the vector registers, the specialized processing unit performs one or more dot product operations by retrieving the matrices from the vector registers.

### BRIEF DESCRIPTION OF THE DRAWINGS

The present disclosure may be better understood, and its numerous features and advantages are made apparent to those skilled in the art by referencing the accompanying drawings. The use of the same reference symbols in different drawings indicates similar or identical items.

FIG. 1 is a block diagram of a processing system configured for matrix multiplication scheduling based on repeated matrix blocks, in accordance with some embodiments.

FIG. 2 is a block diagram of an example processor core configured to schedule instructions based on repeated matrix blocks, in accordance with some embodiments.

FIG. 3 is a block diagram of an example processor core architecture for tracking matrix blocks loaded into the hardware buffers of the AU, in accordance with some embodiments.

FIG. 4 is a flow diagram of an example method for scheduling instructions on an AU based on repeated matrix blocks, in accordance with some embodiments.

### DETAILED DESCRIPTION

Systems and techniques disclosed herein include a processing system configured to implement one or more machine-learning models. For example, while executing certain applications, the processing system is configured to implement machine-learning models such as supervised machine-learning models, unsupervised machine-learning models, reinforcement machine-learning models, neural networks, deep-learning neural networks, large language models, multimedia large language models, and the like that are configured to generate data for the executing applications. These machine-learning models, for example, require the processing system to perform matrix multiplication operations (e.g., dot product operations) using matrices representing weights, biases, scales, and the like of a corresponding machine-learning model. To perform matrix multiplication operations, the processing system includes an accelerator unit (AU) that includes one or more cores that each operate as one or more compute units. A compute unit, for example, includes one or more single instruction, multiple data (SIMD) units having ALU circuitry that includes one or more arithmetic logic units (ALUs) configured to perform a matrix multiplication operation using the data stored in vector registers included in or otherwise connected to the SIMD unit, the hardware buffers of the AU, or any combination thereof. However, the matrices to be multiplied for a machine-learning model are likely to be larger than the cores of the AU can multiply at once. For example, certain matrices to be multiplied are represented by data larger than the ALU circuitry of a SIMD unit of a core can multiply at once. As such, to implement a machine-learning model, the processing system further includes a memory that stores data (e.g., program code) representing one or more instructions to be performed for the machine-learning models. These instructions, for example, each indicate respective portions of matrices to be multiplied based on the size of data able to be multiplied at once by the ALU circuitry of the cores of the AU. For example, to multiply a first matrix by a second matrix, data in the memory indicates instructions that each include a matrix multiplication operation for a corresponding portion of the first matrix and a corresponding portion of the second matrix. These portions of a matrix indicated in the instructions, also referred to herein as “matrix blocks,” each includes at least a portion of a corresponding row or column of a matrix that is based on the size of the hardware buffer of the cores of the AU. As an example, to multiply a 32×32 first matrix by a 32×32 second matrix, each instruction includes a matrix block indicating a respective set of 16 elements of a corresponding row of the first matrix and a matrix block indicating a respective set of 16 elements of a corresponding column of the second matrix.

Further, the processing system includes a central processing unit (e.g., CPU) configured to provide a stream of these instructions to the AU. Based on receiving the instructions, a command processor of the AU schedules the instructions for execution at corresponding compute units. As an example, when allocating an instruction to a compute unit for execution, the AU stores data representing the matrix blocks indicated in the instruction in the vector registers of the core. When the core executes the instructions, a scheduling circuitry of the core reads the matrix blocks from the vector registers and provides these matrix blocks to the ALU circuitry of the SIMD unit which then performs the matrix multiplication operation indicated in the instruction. Further, the core stores each read-out matrix block into a corresponding hardware buffer included in or otherwise connected to the core. However, accessing the vector registers to read matrix data for each instruction to be executed increases the time needed to execute the instructions due to the read-and-write cycle required to read data from the vector registers, provide the data to the ALU circuitry, and store the data in the hardware buffers. As such, to help reduce the amount of data to be read from the vector registers, the AU is configured to schedule instructions for execution based on repeated matrix blocks. As an example, within the data (e.g., program code) stored in the memory of the processing system, the instructions are arranged such that groups of two or more instructions to be executed consecutively share a matrix block to be used in respective matrix multiplication operations. Such groups of two or more instructions to be executed consecutively that share a matrix block are also referred to herein as an “instruction group.” As an example, an instruction group includes a first instruction to be executed first that indicates a first matrix block of a first matrix to be multiplied by a first matrix block of a second matrix, a second instruction to be executed consecutively after the first instruction that indicates the first matrix block of the first matrix is to be multiplied by a second matrix block of the second matrix, and a third instruction to be executed consecutively after the second instruction that indicates that the first matrix block of the first matrix is to be multiplied by a third matrix block of the second matrix.

Based on the data stored in the memory, the CPU then provides an instruction stream to the AU that includes the instruction groups. In response to receiving the instruction stream, a command processor allocates the instructions in the instruction stream to the cores of the AU for execution such that the instruction groups are allocated to respective cores. When allocating instructions including one or more instruction groups to a core, the command processor stores data representing the matrix blocks indicated in the instructions in the vector registers of the core. Additionally, the command processor modifies and stores the instructions in the vector registers such that the instructions each indicate a corresponding matrix multiplication operation is to be performed using data from corresponding vector register addresses storing respective matrix blocks. To execute these instructions allocated to a core, a scheduling circuitry of the core schedules instructions at respective SIMD units for execution. For example, the scheduling circuitry schedules a first instruction of an instruction group to a SIMD unit for execution. When scheduling this first instruction, the scheduling circuitry reads the matrix blocks from the vector register addresses indicated in the first instruction, provides the matrix blocks to the ALU circuitry, and stores the matrix blocks in the hardware buffers of the core. As an example, the scheduling circuitry reads data from vector register addresses indicated in the first instruction, provides such data to the ALU circuitry, and stores the data in the hardware buffers such that the hardware buffers store the matrix blocks associated with the first instruction.

After the SIMD unit performs a matrix multiplication operation using the data read out of the vector registers, the scheduling circuitry schedules a second instruction of the instruction group for execution at the SIMD based on whether a matrix block from the first instruction is to be reused. To determine whether a matrix block from the first instruction is to be reused, the core further includes a tracking circuitry configured to track the matrix blocks loaded into the hardware buffers. As an example, while the scheduling circuitry loads the matrix blocks into the hardware buffers, the tracking circuitry updates one or more tracking entries based on the matrix blocks loaded from the vector registers. That is, the tracking circuitry maintains a corresponding tracking entry for each hardware buffer of the SIMD units of the core with each tracking entry indicating the vector register addresses from which a matrix block loaded into a corresponding hardware buffer was read and whether the matrix block was modified before being loaded into the corresponding hardware buffer.

To schedule the second instruction for execution at the SIMD unit, the scheduling circuitry first compares the vector register addresses indicated in the second instruction to the vector register addresses indicated in the tracking entries of the hardware buffers of the SIMD unit to determine whether a matrix block from the first instruction is reused for the second instruction. Based on the vector register addresses indicated in the instruction matching the vector register addresses indicated in a tracking entry of the hardware buffers and based on the matching tracking entry indicating the matrix block is unmodified, the scheduling circuitry determines that the matrix block stored in the hardware buffer associated with the matching tracking entry is reused for the second instruction. Because the matrix block stored in the hardware buffer associated with the matching tracking entry is reused for the second instruction, the scheduling circuitry does not read data from these vector register addresses and provides the data stored in the corresponding hardware buffer to the ALU circuitry. Further, based on the vector register addresses indicated in the instruction not matching any tracking entry of the hardware buffers or based on a matching tracking entry indicating the matrix block was changed, the scheduling circuitry determines that the matrix block stored in the hardware buffer associated with the matching tracking entry is not reused for the second instruction. Because the matrix block stored in the hardware buffer associated with the matching tracking entry is not reused for the second instruction, the scheduling circuitry reads data from the vector register addresses indicated in the instruction, provides the data to the ALU circuitry, and loads the data into the corresponding hardware buffer. In this way, the processing system is configured to schedule instructions based on repeated (e.g., reused) matrix blocks such that cores of the AU suppress read requests to the vector registers when the matrix block is reused for a second instruction. Because a core suppresses vector register suppresses read requests in this manner, the number of vector register read requests is reduced which, in turn, reduces the overall time and power needed to execute the instructions and implement the machine-learning model. As such, the overall processing efficiency of the processing system is improved when implementing the machine-learning model.

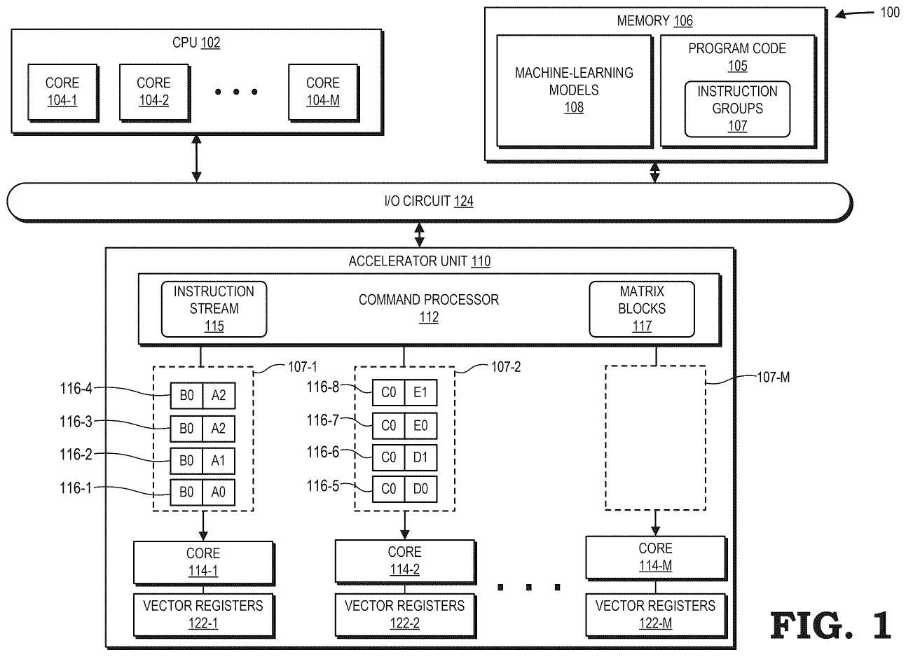

Referring now to FIG. 1, a processing system 100 configured for matrix multiplication instruction scheduling using repeated matrix blocks is presented, in accordance with some embodiments. According to embodiments, processing system 100 is configured to execute applications that require processing system 100 to implement one or more machine-learning models 108 that include one or more supervised machine-learning models, unsupervised machine-learning models, reinforcement machine-learning models, neural networks, deep-learning neural networks, large language models, multimedia large language models, and the like. While implementing a machine-learning model 108, processing system 100 is configured to perform one or more matrix multiplication operations using matrices representing the weights, biases, scales, or combination thereof of the machine-learning model. As an example, to perform such matrix multiplication operations, processing system 100 includes AU 110 which is configured to execute instructions so as to perform one or more matrix multiplication operations for a machine-learning model 108. To implement a machine-learning model, processing system 100 includes or otherwise has access to memory 106 that stores program code 105 for the machine-learning model 108. In some embodiments, memory 106 is implemented using a non-transitory computer-readable medium, for example, a dynamic random-access memory (DRAM) while in other implementations, memory 106 is implemented using other types of memory including, for example, static random-access memory (SRAM), nonvolatile RAM, and the like. Additionally, memory 106, according to some implementations, includes an external memory implemented external to the processing units implemented in the processing system 100. Program code 105 includes, for example, compiled code (e.g., compiled binary code) indicating instructions that, when executed, cause the matrix multiplication operations to be performed for a machine-learning model 108. As an example, program code 105 includes instructions that indicate a corresponding matrix multiplication operation (e.g., matrix dot product operation, MATMUL operation) to be performed using matrices representing weights, biases, scales, or any combination thereof associated with a respective machine-learning model 108.

According to embodiments, the matrix multiplication operations to be performed for a machine-learning model 108 use matrices that are too large to be multiplied at once by processing system 100. As an example, these matrices are too large for the ALU circuitry of AU 110 (e.g., circuitry including one or more ALUs and multiplexers configured to perform a matrix multiplication operation) to multiply at once. As such, the instructions indicated by program code 105 each indicate portions of respective matrices to be multiplied. As an example, for a matrix multiplication operation that multiplies a first matrix by a second matrix, the program code 105 includes two or more instructions each indicating a matrix multiplication operation that multiplies a respective portion of the first matrix by a respective portion of the second matrix. These respective portions of the matrices indicated by the instructions, for example, each include at least a portion of a row or column of a corresponding matrix. As an example, a respective portion of a matrix includes a predetermined number of elements of a row or column of a matrix. According to embodiments, each portion of a matrix indicated by an instruction includes the same number of elements based on the hardware buffers of the AU 110. That is, each portion of a matrix indicated by an instruction includes a predetermined number of elements of a row or column of the matrix that are able to be stored in the hardware buffers of the AU 110. As used herein, these portions of matrices are also referred to herein as “matrix blocks.” For example, within FIG. 1 these portions of matrices indicated by the instructions are represented as matrix blocks 117.

To help schedule execution of the instructions indicated by program code 105, in embodiments, the instructions are arranged in program code 105 such that two or more instructions each indicating the same matrix block 117 are to be executed consecutively. As an example, for a matrix multiplication operation to multiply a first matrix by a second matrix, program code 105 includes a first instruction to be executed first that multiplies a first matrix block 117 of the first matrix by a first matrix block 117 of the second matrix, a second instruction to be consecutively executed after the first instruction that multiplies a second matrix block 117 of the first matrix by the first matrix block 117 of the second matrix, and a third instruction to executed consecutively after the second instruction that multiplies a third matrix block 117 of the first matrix by the first matrix block 117 of the second matrix. As used herein, such groups of instructions to be executed in a successive order are represented in FIG. 1 as “instructions groups 107”. To execute these instruction groups 107, processing system 100 is configured to provide a stream of instructions indicating the instruction groups 107 to AU 110. For example, according to embodiments, processing system 100 includes CPU 102 configured to provide an instruction stream 115 indicating instruction groups 107 to AU 110. As an example, in embodiments, CPU 102 is configured to maintain a command queue (e.g., a circular queue) that stores a set of instructions indicating one or more instruction groups 107. After the command queue is ready to be consumed, AU 110 retrieves the set of instructions for the command queue which forms the instruction stream 115 provided to AU 110. To maintain this command queue, CPU 102 includes one or more processor cores 104 that implement a plurality of processor cores 104-1 to 104-M configured to execute instructions concurrently or in parallel. Though in the example implementation illustrated in FIG. 1, three processor cores (104-1, 104-2, 104-M) are presented representing an M integer number of cores, the number of processor cores 104 implemented in the CPU 102 is a matter of design choice. As such, in other implementations, the CPU 102 can include any non-zero integer number of processor cores 104.

AU 110 is configured to operate as one or more vector processors, coprocessors, graphics processing units (GPUs), general-purpose GPUs (GPGPUs), non-scalar processors, highly parallel processors, artificial intelligence (AI) processors, inference engines, machine-learning processors, other multithreaded processing units, scalar processors, serial processors, programmable logic devices (e.g., field-programmable logic devices (FPGAs)), or any combination thereof. To execute one or more instructions in a received instruction stream, AU 110 implements one or more cores 114 that execute instructions concurrently or in parallel. In some implementations, one or more of the cores 114 each operate as one or more compute units that each include one or more SIMD units configured to perform matrix multiplication operations. As an example, a SIMD unit includes ALU circuitry configured to perform a multiplication operation (e.g., dot product operation) using data (e.g., matrix blocks 117) read out of vector registers 122 included in or otherwise connected to the core 114 including the SIMD unit. Though the example embodiment presented in FIG. 1 shows AU 110 as including three cores (114-1, 114-2, 114-M) representing an M integer number of cores, in other embodiments, AU 110 can include any non-zero integer number of cores 114 each configured to operating as one or more compute units. In some embodiments, to enable communication between CPU 102 and one or more other components (e.g., AU 110, memory 106) of processing system 100, processing system 100 includes input/output (I/O) circuit 124. I/O circuit 124 includes, for example, one or more busses, memory controllers, switches (e.g., PCI switches), data fabrics, queues, buffers, or the like. As an example, I/O circuit 124 is configured to connect a command processor 112 of AU 110 to one or more processor cores 104 of CPU 102, memory 106, or both.

In response to receiving an instruction stream 115, a command processor 112 included in or otherwise connected to AU 110 first allocates respective instructions indicated in instruction stream 115 to one or more cores 114 of AU 110. Such a command processor 112, for example, includes circuitry such as one or more microprocessors, logic gates, buffer queues, and the like configured to schedule instructions for execution by one or more cores 114. When allocating instructions from an instruction stream 115 to the cores 114, in embodiments, the command processor 112 is configured to allocate each instruction in an instruction group 107 to a respective core 114. That is, from the instruction stream 115, the command processor 112 is configured to allocate groups of instructions to be consecutively executed to respective cores 114. As an example, the command processor 112 allocates each instruction from a first instruction group 107-1 to a first core 114-1. This first instruction group 107-1, for example, includes a first instruction 116-1 to be executed that indicates a first matrix block 117 (e.g., B0) of a first matrix is to be multiplied by a first matrix block 117 (e.g., A0) of a second matrix; a second instruction 116-2 to be consecutively executed after the first instruction 116-1 that indicates the first matrix block 117 of the first matrix is to be multiplied by a second matrix block 117 (e.g., A1) of the second matrix; a third instruction 116-3 to be consecutively executed after the second instruction 116-2 that indicates the first matrix block 117 of the first matrix is to be multiplied by a third matrix block 117 (e.g., A2) of the second matrix; and a fourth instruction 116-4 to be executed consecutively after the third instruction 116-3 that indicates the first matrix block 117 of the first matrix is to be multiplied by a fourth matrix block 117 (e.g., A4) of the second matrix. As another example, the command processor 112 allocates each instruction from a second instruction group 107-2 to a second core 114-2. This second instruction group 107-2 includes a first instruction 116-5 to be executed that indicates a first matrix block 117 (e.g., C0) of a third matrix is to be multiplied by a first matrix block 117 (e.g., D0) of a fourth matrix; a second instruction 116-6 to be consecutively executed after the first instruction 116-5 that indicates the first matrix block 117 of the third matrix is to be multiplied by a second matrix block 117 (e.g., D1) of the fourth matrix; a third instruction 116-7 to be consecutively executed after the second instruction 116-6 that indicates the first matrix block 117 of the third matrix is to be multiplied by a first matrix block 117 (e.g., E0) of a fifth matrix; and a fourth instruction 116-8 to be executed consecutively after the third instruction 116-7 that indicates the first matrix block 117 of the third matrix is to be multiplied by a second matrix block 117 (e.g., E1) of the fifth matrix.

According to embodiments, each core 114 of AU 110 includes or is otherwise connected to a respective set of vector registers (122-1, 122-2, 122-M). Each set of vector registers 122, for example, includes a set of addresses (e.g., vector register addresses) configured to store data used in the execution of one or more instructions. As an example, based on command processor 112 allocating the instructions 116 in an instruction group 107 to a core 114, the command processor 112 is configured to store data associated with the instructions 116, such as instructions, operands, values, and the like, in the vector registers 122 associated with the core 114. As an example, the command processor 112 stores data representing the matrix blocks 117 indicated in the instructions 116 allocated to the core 114 in a set of vector register addresses of the vector registers 122. Additionally, in the vector registers 122, the command processor 112 modifies and stores the allocated instructions 116 such that the instructions 116 each indicate a multiplication operation is to be performed using data at corresponding vector register addresses (e.g., the vector registers storing the matrix blocks 117).

After an instruction 116 has been allocated to a core 114, a scheduling circuitry of the core then schedules the instruction 116 for execution by a SIMD unit of the core 114. As an example, the scheduling circuitry first retrieves the first instruction from the vector registers 122 that indicates a first matrix multiplication operation is to be performed using data at certain vector register addresses. The scheduling circuitry then reads the data (e.g., matrix blocks 117) out of the indicated vector register addresses and provides this read-out data to the ALU circuitry of the SIMD unit. Additionally, for each matrix block 117 read out of the vector registers 122, the scheduling circuitry loads data representing the matrix block 117 into a corresponding hardware buffer included in or otherwise connected to the core 114. Such hardware buffers, for example, are each configured to store data representing a matrix block 117. According to some embodiments, after loading a matrix block 117 into a hardware buffer of a core 114, a tracking circuitry of the core 114 is configured to update a tracking entry for the hardware buffer that indicates the vector register addresses from which the loaded matrix block 117 was retrieved and whether the loaded matrix block 117 was modified before being loaded into the hardware buffer. After the ALU circuitry of the SIMD unit executes the matrix multiplication operation using the matrix blocks 117 read out of the vector registers 122, the SIMD unit executes a second instruction allocated to the core 114 by having the scheduling circuitry retrieve a second instruction from the vector registers 122 that indicates a second matrix multiplication operation is to be performed using data at certain vector register addresses. Before the scheduling circuitry retrieves the matrix blocks 117 from the vector registers 122, the scheduling circuitry first compares the vector register addresses indicated in the retrieved second instruction to the tracking entries for the hardware buffers. Based on the vector register addresses in the retrieved instruction matching the vector register addresses in a tracking entry of a hardware buffer and based on the tracking entry indicating that the matrix block 117 was not modified before being loaded into the hardware buffer, the scheduling circuitry determines that the matrix block 117 is being reused (e.g., has already been loaded into the hardware buffers during a previous instruction). Due to the matrix block 117 block being reused, the scheduling circuitry does not again read out the matrix block from the vector registers 122 and instead provides the matrix block 117 from a corresponding hardware buffer to the ALU circuitry. Further, Based on the vector register addresses in the retrieved instruction not matching the vector register addresses in any tracking entry of a hardware buffer or based on the tracking entry indicating that the matrix block 117 was modified before being loaded into the hardware buffer, the scheduling circuitry determines that a new matrix block 117 is needed, reads the matrix block 117 from the indicated vector register addresses in the vector registers 122, and provides the read-out matrix block 117 to the ALU circuitry.

After the matrix blocks 117 have been provided to the ALU circuitry, the ALU circuitry executes the matrix multiplication operation using the provided matrix blocks 117. The SIMD unit then executes a third instruction allocated to the core by again first checking the tracking entries before loading matrix blocks 117 into the hardware buffers. The SIMD unit then continues to schedule instructions in this manner until each instruction allocated to the core 114 unit have been executed. In this way, processing system 100 is configured to schedule instructions 116 for execution by AU 110 based on reused matrix blocks 117. That is, AU 110 schedules instructions 116 for execution such that the cores 114 of AU 110 suppress vector register reads when the matrix block 117 is reused for a second instruction 116. Because the AU 110 suppresses vector register reads in this manner, the number of vector register reads is reduced which reduces the overall time and power needed to execute the instructions 116.

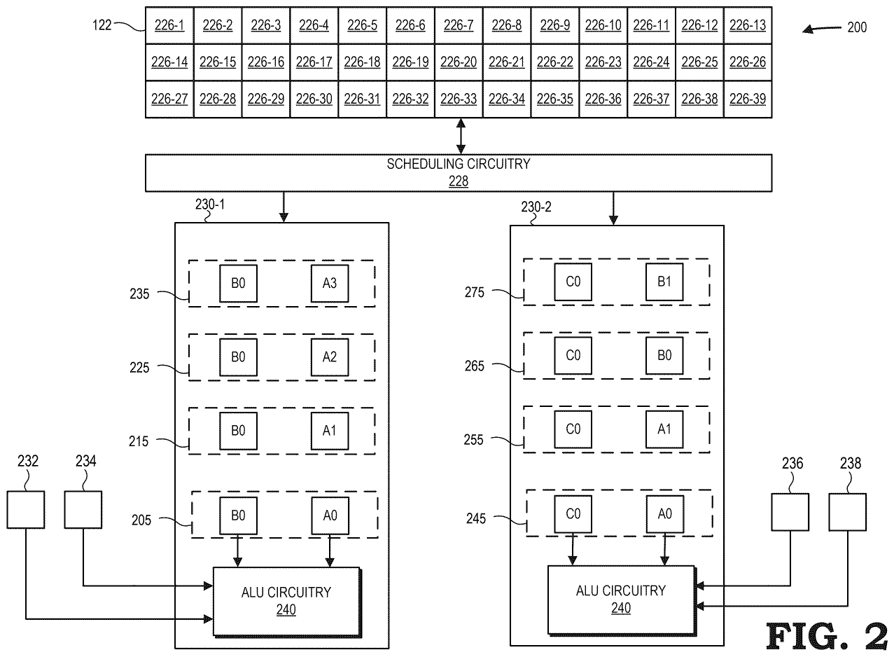

Referring now to FIG. 2, example processor core 200 configured to schedule instructions based on repeated matrix blocks is presented in accordance with embodiments. In embodiments, example processor core 200 is implemented within AU 110. Example processor core 200 is configured to operate as one or more compute units that concurrently perform the same operation on different sets of data. For example, example processor core 200 includes a first SIMD unit 230-1 and a second SIMD unit 230-2. Each SIMD unit 230, for example, includes or is otherwise connected to two hardware buffers configured to store data read from one or more vector registers 122 and provide such data to a corresponding ALU circuitry 240. As an example, within the embodiment presented in FIG. 2, the first SIMD unit 230-1 includes or is otherwise connected to a first hardware buffer 232 and a second hardware buffer 234 and the second SIMD unit 230-2 includes or is otherwise connected to a third hardware buffer 236 and a fourth hardware buffer 238. According to embodiments, each hardware buffer 232, 234, 236, 238 is configured to store a predetermined amount of data. As an example, each hardware buffer 232, 234, 236, 238 is configured to store an amount (e.g., size) of data equal to a matrix block 117 indicated by an instruction 116 provided to the AU 110 including the example processor core 200. That is, each hardware buffer 232, 234, 236, 238 is configured to store data equal in size to a matrix block 117 read out of vector registers 122 for an instruction 116. A corresponding ALU circuitry 240 of a SIMD unit 230 includes one or more ALUs, multiplexers, registers, or any combination thereof configured to perform one or more multiplication (e.g., dot product) operations using data read out of vector registers 122, data stored in the hardware buffers 232, 234, 236, 238 of the SIMD unit 230, or both. Though the example embodiment presented in FIG. 2 shows example processor core 200 as including two SIMD units, in other embodiments, example processor core 200 can include any non-zero integer number of SIMD units 230.

According to embodiments, a command processor 112 of the AU 110 including example processor core 200 is configured to allocate one or more instructions 116 of one or more instruction groups 107 to example processor core 200 for execution. That is, the command processor 112 allocates two or more instructions 116 to be executed in a consecutive order and sharing one or more matrix blocks 117 to example processor core 200 for execution. To allocate these instructions 116 to example processor core 200, the command processor 112 first stores data (e.g., data from memory 106) representing the matrix blocks 117 indicated in the instructions 116 to the vector registers 122 (e.g., general purpose vector registers) included in or otherwise connected to example processor core 200. These vector registers 122, for example, include a number of vector register addresses 226. For example, in the example embodiment presented in FIG. 2, vector registers 122 include vector register addresses 226-1 to 226-39. In embodiments, the command processor 112 is configured to store data representing a respective matrix block 117 at a group of vector register addresses 226. As an example, the command processor 112 is configured to store data representing a matrix block 117 at vector register addresses 226-1, 226-2, 226-3, 226-4, 226-5, 226-6, 226-7, 226-8. Thought the example embodiments presented in FIG. 2 shows vector registers 122 as including 39 vector register addresses (226-1, 226-2, 226-3, 226-4, 226-5, 226-6, 226-7, 226-8, 226-9, 226-10, 226-11, 226-12, 226-13, 226-14, 226-15, 226-16, 226-17, 226-18, 226-19, 226-20, 226-21, 226-22, 226-23, 226-24, 226-25, 226-26, 226-27, 226-28, 226-29, 226-30, 226-31, 226-32, 226-33, 226-34, 226-35, 226-36, 226-27, 226-38, 226-39), in other embodiments, vector registers 122 can include any non-zero integer number of vector register addresses 226. After storing data representing the matrix blocks 117 at corresponding vector register addresses 226, the command processor 112 modifies the instructions 116 of the instruction group 107 such the instructions each indicate that a matrix multiplication operation is to be performed using data at corresponding vector register addresses 226 (e.g., data at corresponding vector register addresses 226 that represents the matrix blocks 117 associated with the instruction 116). To execute the instructions 116 in one or more instruction groups 107 allocated to example processor core 200, a scheduling circuitry 228 included in or otherwise connected to example processor core 200 is configured to schedule the instructions 116 among the SIMD units 230 for execution.

As an example, the scheduling circuitry 228 allocates each instruction 116 in an instruction group 107 to a respective SIMD unit 230 for execution. To schedule a first instruction 116 of a first instruction group 107 (represented in FIG. as instruction 205) for execution at the first SIMD unit 230-1, the scheduling circuitry 228 reads the first instruction 205 from vector registers 122 and provides the read out data (e.g., B0, A0) to the ALU circuitry 240 of the first SIMD unit 230-1. Additionally, after reading out the data from the vector registers 122, the scheduling circuitry 228 is configured to store the read out data in the first hardware buffer 232 and second hardware buffer 234, respectively. For example, the scheduling circuitry 228 loads data representing a first matrix block 117 of a first matrix (e.g., B0) into the first hardware buffer 232 and data representing a first matrix block 117 of a second matrix (e.g., A0) into the second hardware buffer 232. The ALU circuitry 240 then performs a matrix multiplication operation using the read out data and stores the result (e.g., data resulting from the execution of the matrix multiplication operation) in a local data share, cache, vector register 122, or any combination thereof associated with example processor core 200. After the ALU circuitry 240 has completed the multiplication operation for the first instruction 205, the scheduling circuitry 228 schedules a second instruction 116 from the first instruction group 107 (represented in FIG. 2 as instruction 215) by reading at least a portion of the data from the vector register addresses indicated in the second instruction 215 and providing the indicated data (e.g., B0, A1) to the ALU circuitry 240. As an example, the scheduling circuitry 228 reads out data representing a second matrix block 117 of the second matrix (e.g., A1) from the vector registers 122 and provides this data to the ALU circuitry 240. Additionally, the first hardware buffer 234 is configured to provide data representing the first matrix block 117 of the second matrix (e.g., B0) to the ALU circuitry 240. Further, the scheduling circuitry 228 loads the read out data into the second hardware buffer 234. For example, the scheduling circuitry 228 loads data representing the second matrix block 117 of the second matrix (A1) into the second hardware register 234.

After the ALU circuitry 240 performs a matrix multiplication operation using the data indicated in the instruction 215, the scheduling circuitry 228 schedules a third instruction of the first instruction group 107 (represented in FIG. 2 as instruction 225) by providing the data (e.g., B0, A2) indicated in the instruction 225 to the ALU circuitry 240. For example, the scheduling circuitry 228 reads data representing the third matrix block 117 of the second matrix (e.g., A2) from the vector registers 122 and provides this data to the ALU circuitry 240. Additionally, the first hardware buffer 232 provides data representing the first matrix block of the first matrix (e.g., B0) to the ALU circuitry 240. The scheduling circuitry 228 also loads the read out data into the second hardware buffer 234 such that the second hardware buffer 234 stores data representing the third matrix block 117 of the second matrix. Further, after the third instruction 225 is executed, the scheduling circuitry 228 schedules a fourth instruction of the first instruction group 107 (represented in FIG. 2 as instruction 225) such that data (e.g., B0, A3) indicated by the instruction 225 is provided to the ALU circuitry 240. As an example, the scheduling circuitry 228 reads data out of the vector registers 122 indicating a fourth matrix block 117 of the second matrix (e.g., A3) and provides this data to the ALU circuitry 240. Additionally, the first hardware buffer 232 provides data representing the first matrix block 117 of the first matrix to the ALU circuitry 240. The scheduling circuitry 228 is also configured to load the read-out data into the second hardware buffer 234 such that the second hardware buffer 234 stores data representing a fourth matrix block 117 of the second matrix (e.g., A3).

Because the instructions 116 scheduled for execution by the first SIMD unit 230-1 are within the same instruction group 107, the instructions 116 scheduled for execution reuse one or more matrix blocks 117. As an example, within the embodiment presented in FIG. 2, the instructions 205, 215, 225, 235 each use the first matrix block 117 of the first matrix (e.g., B0). As another example, when scheduling a first instruction (e.g., an instruction 116) of a second instruction group 107 (represented in FIG. 2 as instruction 245) for execution at the second SIMD unit 230-2, the scheduling circuitry 228 reads data from the vector register addresses 226 indicated in the instruction 245 and provides this read out data (e.g., C0, A0) to the ALU circuitry 240. Further, the scheduling circuitry 228 loads this read out data into the hardware buffers such that the third hardware buffer 236 stores data indicating a first matrix of a third matrix (e.g., C0) and the fourth hardware buffer 238 stores data indicating the first matrix of the first matrix (e.g., A0). After the corresponding ALU circuitry 240 performs the matrix multiplication operation for the instruction 245, the scheduling circuitry 228 schedules a second instruction of the second instruction group 107 (represented in FIG. 2 as instruction 255) for execution by providing the data (e.g., C0, A1) indicated by the instruction 255 to the ALU circuitry 240. As an example, the scheduling circuitry 228 reads data representing the second matrix block 117 of the second matrix (e.g., A2) from the vector registers 122 and provides this read out data to the ALU circuitry 240 while the third hardware buffer 236 provides data representing the first matrix block 117 of the third matrix (e.g., C0) to the ALU circuitry 240. The scheduling circuitry 228 also loads the data representing the second matrix block 117 of the first matrix (e.g., A1) into the fourth hardware buffer 238. After another matrix multiplication operation is performed by ALU circuitry 240, the scheduling circuitry 228, for a third instruction of the second instruction group 107 (represented in FIG. 2 as instruction 265) provides the data (e.g., C0, B0) indicated by the instruction 265 to the ALU circuitry 240. For example, the scheduling circuitry 228 read data representing the first matrix block 117 of the first matrix (e.g., B0) from the vector registers 122 and provides this data to the ALU circuitry 240 while the third hardware buffer 236 provides data representing the first matrix block 117 of the third matrix to the ALU circuitry 240. Further, the scheduling circuitry 128 loads data representing the first matrix block 117 of the second matrix (e.g., B0) into the fourth hardware buffer 238. Additionally, for a fourth instruction of the second instruction group 107 (represented in FIG. 2 as instruction 275), the scheduling circuitry 228 provides the data (e.g., C0, B1) indicated by the instruction 275 to the ALU circuitry 240. As an example, the scheduling circuitry 228 reads data representing the second matrix block 117 of the first matrix (e.g., B1) from the vector registers 122 and provides this data to the ALU circuitry 240 while the third hardware buffer 236 provides data representing the first matrix block 117 of the third matrix to the ALU circuitry 240. Additionally, the scheduling circuitry 228 loads data representing the second matrix block 117 of the second matrix (e.g., B1) into the fourth hardware buffer 238.

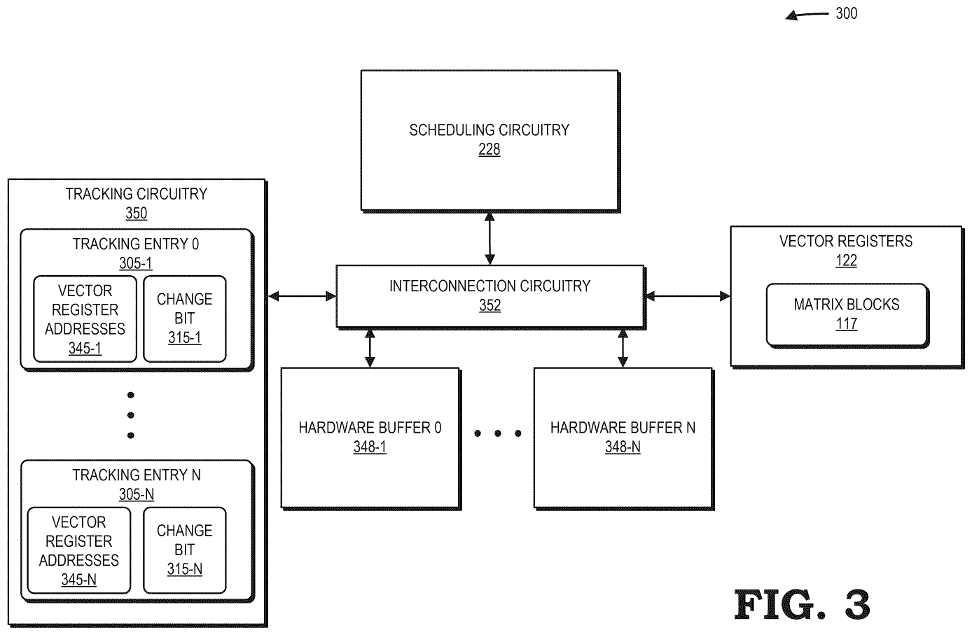

In embodiments, scheduling circuitry 228 is configured to provide data to the ALU circuitry 240 based on one or more tracking entries maintained by a tracking circuitry. For example, referring now to FIG. 3, an example processor core architecture 300 for tracking matrix blocks loaded into hardware buffers of an AU is presented, in accordance with embodiments. According to embodiments, example processor core architecture 300 is implemented in one or more cores 114, example processor core 200, or both. To facilitate communication between components (e.g., tracking circuitry 350, scheduling circuitry 228, hardware buffers 348, vector registers 122) of example processor core architecture 300, example processor core architecture 300 includes interconnection circuitry 352. Such interconnection circuitry 352 includes, for example, one or more busses, memory controllers, switches (e.g., PCI switches), data fabrics, queues, buffers, or the like configured to communicatively couple two or more components of example processor core architecture to one another using one or more communication protocols.

To enable a processor core to track data loaded into hardware buffers, example processor core architecture 300 includes a tracking circuitry 350 configured to track the data loaded into each hardware buffer, similar to or the same as hardware buffers 232, 234, 236, 238, of one or more SIMD units 230 of a processor core. Such hardware buffers having their data tracked by the tracking circuitry 350 are represented in FIG. 3 as two hardware buffers (348-1, 348-N) representing an N integer number of hardware buffers. However, in other embodiments, tracking circuitry 350 is configured to track the data in any non-zero number of hardware buffers 348 based on the number of SIMD units 230 in the processor core. The tracking circuitry 350 includes, for example, one or more microprocessors, storages, logic gates, buffer queues, and the like configured to track data loaded into hardware buffers 348 from vector registers 122. As an example, when scheduling circuitry 228 schedules an instruction 116 for execution, the scheduling circuitry 228 first determines the vector register addresses 226 indicated by the instruction 116. The scheduling circuitry 228 then sends one or more read requests to the vector registers 122 based on vector register addresses 226 indicated by the instruction 116. That is, the scheduling circuitry sends one or more read requests identifying vector register addresses 226 corresponding to the matrix blocks 117 indicated by the instruction 116. After reading one or more matrix blocks 117 from the vector registers 122, the scheduling circuitry 228 sends a respective write request to corresponding hardware buffers 348 which loads the read out matrix blocks 117 into the corresponding hardware buffers 348.

While scheduling circuitry 228 is loading data into the hardware buffers 348, the tracking circuitry 350 is configured to monitor (e.g., snoop) interconnection circuitry 352 for write requests sent by scheduling circuitry 228. Based on detecting a write request on interconnection circuitry 352, the tracking circuitry 350 updates a tracking entry 305 associated with the hardware buffer 348 indicated by the write request. Such tracking entries 305, for example, are stored in tracking circuitry 350 and are each associated with a corresponding hardware buffer 348. Further, each tracking entry 305 indicates a set of vector register addresses (e.g., set of vector register addresses 345-1, 345-N) identified in a detected write request and a change bit (e.g., change bit 315-1, 315-N) indicating whether the data indicated in the write request was or is to be modified before being stored in a hardware buffer 348. As an example, based on detecting a write request on interconnection circuitry 352, the tracking circuitry 350 modifies the tracking entry associated with the hardware buffer 348 indicated in the write request such that the tracking entry 305 indicates the set of vector register addresses 345 indicated in the write request. That is, based on data being loaded into a hardware buffer 348, the tracking circuitry 350 modifies the tracking entry associated with the hardware buffer 348 such that the tracking entry 305 indicates the set of vector register addresses 345 from which the loaded data was read. Further, the tracking circuitry 350 is configured to update the change bit 315 of the tracking entry 305 based on whether the data indicated in the write quest is modified before being stored in a corresponding hardware buffer 348. That is, based on whether the matrix block 117 represented by the data indicated in the write quest is modified before being stored in a corresponding hardware buffer 348. As an example, in response to the write request indicating that a matrix block 117 (e.g., data representing the matrix block 117) is modified before being stored in a hardware buffer 348, tracking circuitry 350 sets the change bit to a first value to indicate that the matrix block 117 was modified. Further, in response to the write request indicating that a matrix block 117 is not modified before being stored in a hardware buffer 348, tracking circuitry 350 sets the change bit to a first value to indicate that the matrix block 117 was modified. Though the example embodiment presented in FIG. 3 shows the tracking circuitry 350 as maintaining two tracking entries (305-1, 305-N) representing an N integer number of tracking entries (e.g., one for each hardware buffer 348), in other embodiments, tracking circuitry 350 is configured to maintain any non-zero integer number of tracking entries 305.

In embodiments, scheduling circuitry 228 is configured to check the tracking entries 305 before sending a read request to vector registers 122. For example, when scheduling an instruction 116 for execution at a SIMD unit 230, the scheduling circuitry 228 compares the vector register addresses 226 indicated in the instruction 116 to be executed to the tracking entries 305 associated with the SIMD unit 230 (e.g., associated with the hardware buffers 348 of the SIMD unit 230). Based on the vector register addresses 226 indicated in the instruction 116 not matching the sets of vector register addresses 345 of any tracking entry 305, the scheduling circuitry 228 determines that the data (e.g., matrix block 117) to be read from the vector registers 122 is not already stored in the hardware buffers 348 of the SIMD unit 230 and sends a read request to the vector registers 122 so as to provide data to a corresponding ALU circuitry 240. Further, based on the vector register addresses 226 indicating in the instruction 116 matching the set of vector register addresses 345 of a tracking entry 305, the scheduling circuitry 228 determines whether the change bit 315 of the matching tracking entry 305 indicates that the data (e.g., matrix block 117) was modified before being loaded into the hardware buffer 348 associated with the tracking entry 305. In response to the change bit 315 indicating that the data was modified, the scheduling circuitry 228 determines that the data (e.g., matrix block 117) to be read from the vector registers 122 is not already stored in the hardware buffers 348 of the SIMD unit 230 and sends a read request to the vector registers 122 so as to provide data to a corresponding ALU circuitry 240. Additionally, in response to the change bit 315 indicating that the data was not modified, the scheduling circuitry 228 determines that the data (e.g., matrix block 117) is already loaded into the hardware buffer 348 associated with the tracking entry 305 and suppresses a read request such that a read request identifying the set of vector register addresses 345 in the matched tracking entry 305 is not sent to the vector registers 122. That is, in response to vector register addresses 226 indicated in a write request matching a set of vector register addresses 345 in a tracking entry 305 and based on the change bit 315 of the tracking entry 305 indicating that the data was not modified before being loaded into a corresponding hardware buffer 348, scheduling circuitry 228 determines that the data is already loaded into the hardware buffer 348 associated with the tracking entry 305 and does not send a read request to the vector registers 122. The hardware buffer 348 then provides the data stored in the hardware buffer 348 (e.g., the reused matrix block 117) to a corresponding ALU circuitry 240. Because the scheduling circuitry 228 suppresses reads to the vector registers 122 in this way, the number of reads to the vector registers 122 is reduced which reduces the overall time and power needed to execute the instructions 116 and implement a corresponding machine-learning model 108.

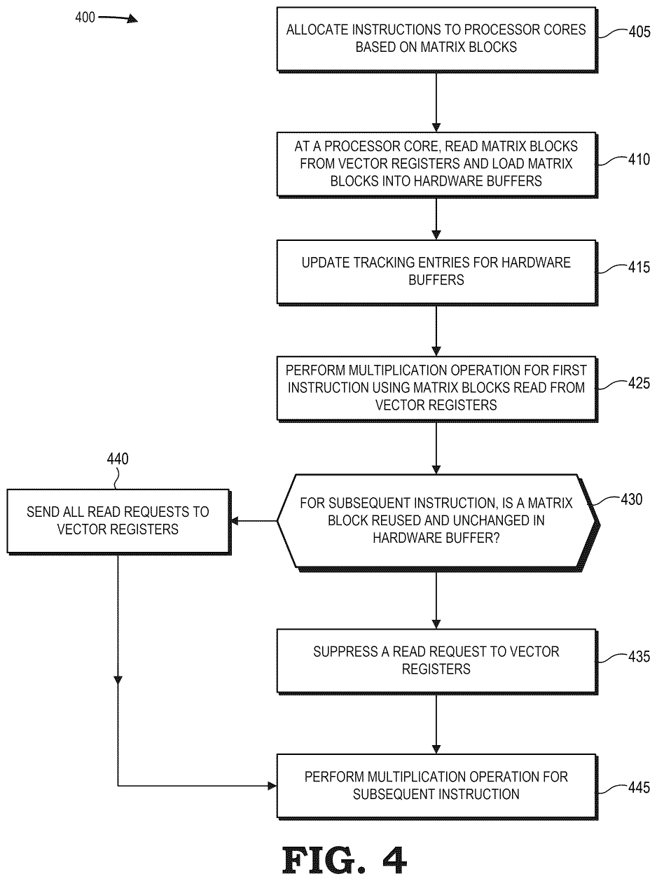

Referring now to FIG. 4, an example method 400 for scheduling instructions on an AU based on repeated matrix blocks, in accordance with embodiments. According to embodiments, example method 400 is implemented at least in part by AU 110. Example method 400 includes, at block 405, a command processor 112 of AU 110 allocating instructions 116 in instruction groups 107 to the cores 114 of AU 110. For example, the command processor 112 allocates instructions 116 of one or more instruction groups 107 to a corresponding core 114. To allocate such instructions 116 to a core 114, the command processor 112 stores data, from for example memory 106, indicating the matrix blocks 117 of the instructions 116 at respective vector register addresses 226 of vector registers 122 included in or otherwise connected to the core 114. Further, the command processor 112 modifies the instructions 116 such that each instruction indicates a matrix multiplication operation is to be performed using data at corresponding vector register addresses 226 (e.g., vector register addresses 226 storing data representing the matrix blocks 117 of the instruction). After the command processor 112 has allocated instructions 116 of one or more instructions groups 107 to a core 114, at block 410, a scheduling circuitry 228 of the core 114 schedules a first allocated instruction 116 for execution at a SIMD unit 230 of the core 114. For example, still referring to block 410, the scheduling circuitry 228 sends a read request to vector registers 122 indicating the vector register addresses 226 identified in the first allocated instruction. After data from these vector register addresses 226 is read out, the scheduling circuitry 228 provides the data to the ALU circuitry 240 of the SIMD unit 230. Additionally, the scheduling circuitry 228 loads the read out data into one or more hardware buffers 348 of the SIMD unit 230. For example, still referring to block 410, the scheduling circuitry 228 sends a write request to the hardware buffers 348 of the SIMD unit 230 so as to write the readout data (e.g., read out matrix blocks 117) into corresponding hardware buffers 348 of the SIMD unit 230.

At block 415, a tracking circuitry 350 of the core 114 is configured to update one or more tracking entries 305 based on the data indicated in the first allocated instruction. For example, tracking circuitry 350 is configured to monitor (e.g., snoop) an interconnection circuitry 352 for write requests sent from scheduling circuitry 228 to the hardware buffers 348. In response to detecting a write request sent to a hardware buffer 348, the tracking circuitry 350 updates a tracking entry 305 associated with the hardware buffer 348. As an example, the tracking circuitry 350 updates the tracking entry 305 to indicate the set of vector register addresses 345 from which data (e.g., the matrix block 117) was read before being loaded into the hardware buffer 348. Additionally, the tracking circuitry updates a change bit 315 of the tracking entry 305 based on whether the data read from the set of vector register addresses 345 was modified before being loaded into the hardware buffer 348. Based on a write request indicating that the data was modified before being loaded into the hardware buffer 348, the tracking circuitry sets to the change bit 315 to a first value indicating the data was modified. Further, based on a write request indicating that the data was not modified before being loaded into the hardware buffer 348, the tracking circuitry sets to the change bit 315 to a second value indicating the data was not modified. At block 425 of example method 400, the SIMD unit 230 performs a matrix multiplication operation using the data (e.g., matrix blocks 117) read out of the vector registers 122.

After performing the matrix multiplication operation for the first allocated instruction, at block 430, the SIMD unit 230 is configured to execute a second allocated instruction (e.g., execute a subsequent instruction). For example, to execute a second allocated instruction at the SIMD unit 230, the scheduling circuitry 228 first determines the vector register addresses 226 indicated in the second allocated instruction and compares these vector register addresses 226 to the tracking entries 305 associated with the hardware buffers 348 of the SIMD unit 230. Based on the vector register addresses 226 of the second allocated instruction not matching any of the tracking entries 305 associated with the hardware buffers 348 of the SIMD unit 230, the scheduling circuitry 228 determines that a matrix block 117 from the first allocated instruction is not reused for the second allocated instruction and moves to block 440. Further, based on vector register addresses 226 of the second allocated instruction matching a tracking entry 305 associated with a hardware buffer 348 of the SIMD unit 230, the scheduling circuitry 228 checks the change bit 315 of the matched tracking entry 305 to determine whether the data from the set of vector register addresses 345 indicated in the matched tracking entry 305 was modified before being loaded into a corresponding hardware buffer 348. In response to determining that data from the set of vector register addresses 345 was modified before being loaded into a corresponding hardware buffer 348, the scheduling circuitry 228 determines that a matrix block 117 from the first allocated instruction is not reused for the second allocated instruction and moves to block 440. Additionally, in response to determining that data from the set of vector register addresses 345 was not modified before being loaded into a corresponding hardware buffer 348, the scheduling circuitry 228 determines that a matrix block 117 from the first allocated instruction is reused for the second allocated instruction and moves to block 435. At block 435, the scheduling circuitry 228 suppresses a read request to the vector registers 122 such that a read request identifying the set of vector register addresses 345 of the matched entry is not sent to the vector registers 122 and data from the hardware register 348 associated with the matched entry is provided to the ALU circuitry 240 of the SIMD unit 230.

As such, the scheduling circuitry 228 only sends a read request to the vector registers 122 identifying the set of vector register addresses 345 that store matrix blocks 117 that are not reused from the first allocated instruction. For example, at block 440, based on the scheduling circuitry determining that no matrix blocks 117 are reused from the first allocated instruction to the second allocated instruction, the scheduling circuitry 228 sends read requests to the vector registers 122 identifying all the vector register addresses 226 indicated by the second allocated instruction and provides the read out data to the ALU circuitry 240 of the SIMD unit 230. At block 445, the SIMD unit 230 performs a matrix multiplication operation using the data indicated by the second allocated instruction.

In some embodiments, the apparatus and techniques described above are implemented in a system including one or more integrated circuit (IC) devices (also referred to as integrated circuit packages or microchips), such as the AU described above with reference to FIGS. 1-4. Electronic design automation (EDA) and computer aided design (CAD) software tools may be used in the design and fabrication of these IC devices. These design tools typically are represented as one or more software programs. The one or more software programs include code executable by a computer system to manipulate the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer readable storage medium accessible to the computing system. Likewise, the code representative of one or more phases of the design or fabrication of an IC device may be stored in and accessed from the same computer readable storage medium or a different computer readable storage medium.

A computer readable storage medium may include any non-transitory storage medium, or combination of non-transitory storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory) or coupled to the computer system via a wired or wireless network (e.g., network accessible storage (NAS)).

In some embodiments, certain aspects of the techniques described above may be implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is set forth in the claims below.

What is claimed is:

1. An accelerator unit (AU), comprising:
a plurality of vector registers configured to store data associated with a plurality of instructions; and
one or more processor cores, each configured to:
maintain a tracking entry for a hardware buffer of the processor core, wherein the tracking entry indicates a set of vector register addresses of the plurality of vector registers;
read a matrix block indicated in an instruction of the plurality of instructions from the plurality of vector registers based on the tracking entry associated with the hardware buffer; and
perform a matrix multiplication operation using the matrix block.

2. The AU of claim 1, wherein the plurality of instructions includes two or more instructions to be executed consecutively that share the matrix block.

3. The AU of claim 1, wherein each processor core of the one or more processor cores is configured to:
in response to a read request to the plurality of vector registers, update the tracking entry of the hardware buffer to indicate the set of vector register addresses.

4. The AU of claim 1, wherein each processor core of the one or more processor cores is configured to:
send a read request to the plurality of vector registers based on vector register addresses indicated by the instruction not matching the set of vector register addresses of the tracking entry.

5. The AU of claim 1, wherein each processor core of the one or more processor cores is configured to:
suppress a read request to the plurality of vector registers so that the read request is not sent based on vector register addresses indicated by the instruction matching the set of vector register addresses of the tracking entry.

6. The AU of claim 1, wherein the tracking entry further indicates whether the matrix block was changed before being loaded into the hardware buffer.

7. The AU of claim 1, wherein each processor core of the one or more processor cores is configured to:
send a read request to the plurality of vector registers based on the tracking entry indicating that the matrix block was changed before being loaded into the hardware buffer.

8. A method, comprising:
maintaining, by an accelerator unit (AU), a tracking entry for a hardware buffer of a processor core of the AU, wherein the tracking entry indicates a set of vector register addresses of a plurality of vector registers;
reading a matrix block indicated in an instruction to be executed by the AU from the plurality of vector registers based on the tracking entry associated with the hardware buffer; and
performing, by the AU, a matrix multiplication operation using the matrix block.

9. The method of claim 8, further comprising:
storing, by a memory, a plurality of instructions including the instruction to be executed by the AU, wherein the plurality of instructions includes two or more instructions to be executed consecutively that share the matrix block.

10. The method of claim 8, further comprising:
in response to a read request to the plurality of vector registers, updating the tracking entry of the hardware buffer to indicate the set of vector register addresses.

11. The method of claim 8, further comprising:
sending a read request to the plurality of vector registers based on vector register addresses indicated by the instruction not matching the set of vector register addresses of the tracking entry.

12. The method of claim 8, further comprising:
suppressing a read request to the plurality of vector registers so that the read request is not sent based on vector register addresses indicated by the instruction to be executed by the AU matching the set of vector register addresses of the tracking entry.

13. The method of claim 8, wherein the tracking entry further indicates whether the matrix block was changed before being loaded into the hardware buffer.

14. The method of claim 13, further comprising:
sending a read request to the plurality of vector registers based on the tracking entry indicating that the matrix block was changed before being loaded into the hardware buffer.

15. An accelerator unit (AU), comprising:
a plurality of vector registers; and
one or more processor cores each configured to:
maintain a tracking entry for a hardware buffer of the processor core;
provide a matrix block for an instruction to an arithmetic logic unit (ALU) circuitry by sending a read request to the plurality of vector registers based on whether vector register addresses indicated in the instruction match a set of vector register addresses in the tracking entry; and
perform, by the ALU circuitry, a matrix multiplication operation using the matrix block.

16. The AU of claim 15, wherein each processor core of the one or more processor cores is configured to:
based on data being loaded into the hardware buffer, update the tracking entry of the hardware buffer to indicate the set of vector register addresses.

17. The AU of claim 15, wherein each processor core of the one or more processor cores is configured to:
send the read request to the plurality of vector registers based on the vector register addresses indicated by the instruction not matching the set of vector register addresses of the tracking entry.

18. The AU of claim 15, wherein each processor core of the one or more processor cores is configured to:
suppress the read request to the plurality of vector registers so that the read request is not sent based on the vector register addresses indicated by the instruction matching the set of vector register addresses of the tracking entry.

19. The AU of claim 15, wherein the tracking entry further indicates whether the matrix block was changed before being loaded into the hardware buffer.

20. The AU of claim 19, wherein each processor core of the one or more processor cores is configured to:
send the read request to the plurality of vector registers based on the tracking entry indicating that the matrix block was changed before being loaded into the hardware buffer.
